(19) United States
(12) Patent Application Publication
(10) Pub. No.: US 2023/0192012 A1
(43) Pub. Date: Jun. 22, 2023

(54) VEHICLE UPPER STRUCTURE

(71) Applicant: MAZDA MOTOR CORPORATION, Hiroshima (JP)

(72) Inventors: Miho KURATA, Aki-gun (JP); Sakayu TERADA, Aki-gun (JP); Daisuke YAMADA, Aki-gun (JP); Kohya NAKAGAWA, Aki-gun (JP); Akinori UTSUNOMIYA, Aki-gun (JP); Koki YAMASHITA, Aki-gun (JP); Kenji MATSUMOTO, Aki-gun (JP)

(73) Assignee: MAZDA MOTOR CORPORATION, Hiroshima (JP)

(21) Appl. No.: 18/058,078

(22) Filed: Nov. 22, 2022

(30) Foreign Application Priority Data
Dec. 17, 2021 (JP) 2021-205113

(51) Int. Cl. B60R 13/08; B62D 25/06; B60R 13/02

(52) U.S. Cl. CPC B60R 13/0815; B62D 25/06; B60R 13/0212

(57) ABSTRACT

A vehicle upper structure reduces noise in a cabin by preventing vibration of a roof panel while avoiding an increase in manufacturing cost and an increase in vehicle weight. A vehicle includes a roof panel, a front header, a ceiling, and a vibration damping member. The front header extends in a vehicle width direction on an inner side of the cabin from the roof panel. The ceiling covers the roof panel from the inner side of the cabin. The vibration damping member is fixed to an upper surface of the ceiling. The vibration damping member is arranged between a sun visor fixed portion and a gusset fixed portion in the vehicle width direction and near the front header. The vibration damping member has at least two resonance frequencies and is configured such that one resonance frequency thereof is substantially the same as a resonance frequency of the ceiling.

### TECHNICAL FIELD

The present disclosure relates to a vehicle upper structure and, in particular, to a vibration prevention structure for a top ceiling in a vehicle.

### BACKGROUND

Currently, vehicle weight reduction has been promoted for purposes of improving fuel economy and the like. When the vehicle weight reduction is promoted, just as described, noise reduction in the cabin becomes important. In particular, in regard to a top ceiling that is attached to a roof panel in a manner to cover the inside of the cabin, vibration of the top ceiling is considered as a major source of the noise in the cabin.

In Japanese Patent Document JP-A-2015-151105, a vehicle upper structure is disclosed. In the vehicle upper structure, a vibration-damping reinforcement member is interposed between the roof panel and the top ceiling. The vibration-damping reinforcement member in JP-A-2015-151105 includes: a base material layer that is formed from urethane foam and the like; and a surface skin layer that is formed from paper, a resin, and the like and is stacked on each of front and back surfaces of the base material layer. The vibration-damping reinforcement member is disposed with a clearance being provided between the vibration-damping reinforcement member and the roof panel. In addition, plural holes are provided to the surface skin layer, which faces the roof panel, in the vibration-damping reinforcement member.

### SUMMARY

However, since the vibration-damping reinforcement member disclosed in JP-A-2015-151105 is provided to cover a substantially entire surface on the roof panel side of the top ceiling, there are problems of increased manufacturing cost and increased vehicle weight.

The present disclosure has been made to solve the problems as described above and therefore has a purpose of providing a vehicle upper structure capable of preventing vibration of a top ceiling to reduce noise in a cabin while preventing an increase in manufacturing cost and an increase in vehicle weight.

A vehicle upper structure according to an aspect of the present disclosure includes a roof panel, a body frame member, a top ceiling, and a vibration damping member. The body frame member is a member that is disposed on an inner side of a cabin from the roof panel and extends in a vehicle width direction. The top ceiling is a member that is disposed on the inner side of the cabin from the body frame member and covers the roof panel from the inner side of the cabin. The vibration damping member is a member that is fixed to an upper surface on the roof panel side of the top ceiling.

In the vehicle upper structure according to this aspect, the top ceiling has a first fixed portion and a second fixed portion that are fixed to the body frame member at separated positions from each other in the vehicle width direction. The vibration damping member is disposed between the first fixed portion and the second fixed portion in the vehicle width direction proximal the body frame member, has at least two resonance frequencies, and is configured that one resonance frequency of the at least two resonance frequencies is substantially the same as a resonance frequency of the top ceiling.

In the vehicle upper structure according to the above aspect, the vibration damping member is arranged near (i.e., proximal) the body frame member. Therefore, it is possible to avoid an increase in manufacturing cost and an increase in weight in comparison with the structure disclosed in above JP-A-2015-151105 in which the vibration-damping reinforcement member is disposed in the manner to cover the substantially entire upper surface of the top ceiling.

In addition, in the vehicle upper structure according to the above aspect, the vibration damping member is disposed between the first fixed portion and the second fixed portion. Accordingly, although the top ceiling attempts to vibrate due to vibration energy that is transmitted from the body frame member to the top ceiling via the first fixed portion and the second fixed portion, the vibration damping member that is disposed between the first fixed portion and the second fixed portion (a central portion of an area where the vibration occurs) can dampen the vibration energy, and thus can prevent the vibration.

Furthermore, in the vehicle upper structure according to the above aspect, the vibration damping member has the at least two resonance frequencies, and the vibration damping member is formed such that the one resonance frequency thereof is substantially the same as the resonance frequency of the top ceiling. Accordingly, at the resonance frequency that is aimed to reduce the vibration of the top ceiling, an amplitude can be dampened, and the amplitude can also be dampened at another resonance frequency.

Therefore, in the vehicle upper structure according to the above aspect, it is possible to dampen the vibration of the top ceiling in plural frequency ranges.

In the above aspect, “substantially the same” means not only the case where the one resonance frequency of the vibration damping member matches the resonance frequency of the top ceiling but also inclusion of a frequency range at a base of a peak of the resonance frequency of the top ceiling.

In the vehicle upper structure according to the above aspect, the vibration damping member may have a loss factor of 0.01 or higher.

In the vehicle upper structure according to the above aspect, the loss factor of the vibration damping member is set to 0.01 or higher. Thus, it is possible to obtain a high effect of dampening the vibration of the top ceiling.

In the vehicle upper structure according to the above aspect, the vibration damping member may have: a columnar first portion that is fixed to the upper surface and extends toward the roof panel side; and a second portion that is connected to an upper end of the first portion, has a larger area than the first portion in a plan view, and is formed such that at least a part of a lateral periphery thereof is a free end.

In the vehicle upper structure according to the above aspect, the vibration damping member has the second portion, the area of which is larger than that of the first portion in the plan view, and at least the part of the lateral periphery of the second portion is the free end. Accordingly, the vibration damping member obtains the configuration of having the at least two resonance frequencies, and significant distortion of the vibration damping member, which is caused by vibration of the free end of the second portion, effectively dampens the vibration. Therefore, the vibration damping member is suitable for preventing the vibration of the top ceiling.

In the vehicle upper structure according to the above aspect, the vibration damping member may have: a columnar first portion that is fixed to the upper surface and extends toward the roof panel side; and a second portion that is connected to an upper end of the first portion and has a higher Young's modulus than the first portion.

In the vehicle upper structure according to the above aspect, the vibration damping member has the second portion, Young's modulus of which is higher than that of the first portion. Accordingly, the vibration damping member obtains the configuration of having the at least two resonance frequencies due to compression of the first portion, and the significant distortion of the vibration damping member, which is caused by expansion/compression vibration of the first portion, can effectively dampen the vibration. Therefore, in the vehicle upper structure according to the above aspect, the vibration of the top ceiling can be dampened with the simple and light-weight structure.

In the vehicle upper structure according to the above aspect, when a linear distance between the first fixed portion and a second fixed portion is set as an inter-fixed portion distance, in the plan view, the vibration damping member may be arranged on an imaginary line that connects the first fixed portion and the second fixed portion or within a range, a distance from which to the imaginary line is equal to or shorter than a distance corresponding to the inter-fixed portion distance in a front-rear direction.

In the vehicle upper structure according to the above aspect, the vibration damping member is arranged on the imaginary line or within the range, the distance from which to the imaginary line is equal to or shorter than the corresponding distance. Therefore, in the central portion, which is located between the first fixed portion and the second fixed portion, in the area where the vibration occurs, the vibration energy can be dampened and reduced by the vibration damping member.

The vehicle upper structure according to the above aspect further includes a second body frame member that is arranged between the roof panel and the top ceiling, is arranged behind and away from a first body frame member, and extends in the vehicle width direction when the body frame member is set as the first body frame member. In the plan view, the vibration damping member may be arranged in an area between the first fixed portion and the second fixed portion in the vehicle width direction and in an area between the first body frame member and the second body frame member in the front-rear direction.

In the vehicle upper structure according to the above aspect, the vibration damping member is arranged in the above area. Therefore, in the central portion of the area where the vibration occurs in both of the vehicle width direction and the front-rear direction, the vibration energy can be dampened by the vibration damping member.

In the vehicle upper structure according to the above aspect, the body frame member may be a front header.

In the vehicle upper structure, the front header is adopted as the body frame member. Accordingly, the vibration damping member is arranged near the front header, and the vibration damping member can reliably receive the vibration that is transmitted from a front suspension via the front header. Therefore, in the vehicle upper structure according to the above aspect, it is possible to prevent noise in the cabin by effectively preventing the vibration of the top ceiling.

In the vehicle upper structure according to the above aspect, the first fixed portion may be a sun visor fixed portion at which a sun visor is fixed with the top ceiling to the body frame member, and the second fixed portion may be a gusset fixed portion at which the top ceiling is fixed to the body frame member via a gusset.

In the vehicle upper structure according to the above aspect, the sun visor fixed portion is adopted as the first fixed portion, and the gusset fixed portion is adopted as the second fixed portion. Accordingly, the vibration damping member, which is disposed between the first fixed portion (the sun visor fixed portion) and the second fixed portion (the gusset fixed portion), can reliably receive the vibration that is transmitted from the front suspension via the front header. Therefore, in the vehicle upper structure according to the above aspect, it is possible to prevent the noise in the cabin by effectively preventing the vibration of the top ceiling.

In the vehicle upper structure according to the above aspect, the body frame member may be a rear header.

In the vehicle upper structure according to the above aspect, the rear header is adopted as the body frame member. Accordingly, the vibration damping member is arranged near the rear header, and the vibration damping member can reliably receive the vibration that is transmitted from a rear suspension via the rear header. Therefore, in the vehicle upper structure according to the above aspect, it is possible to prevent the noise in the cabin by effectively preventing the vibration of the top ceiling.

In the vehicle upper structure according to each of the above aspects, it is possible to prevent the noise in the cabin by preventing the vibration of the top ceiling while preventing the increase in the manufacturing cost and the increase in the vehicle weight.

### BRIEF DESCRIPTION OF THE DRAWINGS

FIG. 1 is a plan view illustrating a vehicle upper structure according to a first embodiment of the present disclosure.

FIG. 2 is a schematic view illustrating a position at which a vibration damping member is disposed.

FIGS. 3A-3B include views illustrating a structure of the vibration damping member, in which FIG. 3A is a side view and FIG. 3B is a bottom view.

FIGS. 4A-4C include views illustrating vibration modes of the vibration damping member, in which FIG. 4A illustrates a mode in which an end portion vibrates, FIG. 4B illustrates a mode in which the entire the vibration damping member vibrates, and FIG. 4C illustrates a mode in which the vibration damping member vibrates to flex.

FIG. 5 is a characteristic graph illustrating a natural vibration mode of the vibration damping member.

FIG. 6 is a graph illustrating a relationship between a loss factor and a primary resonance peak reduction amount of the vibration damping member.

FIG. 7 is a perspective view in which a top ceiling used in a vibration test on a test bed is seen obliquely from above.

FIG. 8 is a schematic view illustrating positions at each of which body sensitivity was measured in the vibration test on the test bed.

FIG. 9A is a perspective view illustrating a disposed position of the vibration damping member, and FIG. 9B is a characteristic graph illustrating a relationship between a frequency and ERP.

FIG. 10A is a perspective view illustrating a disposed position of the vibration damping member, and FIG. 10B is a characteristic graph illustrating the relationship between the frequency and the ERP.

FIG. 11A is a perspective view illustrating a disposed position of the vibration damping member, and FIG. 11B is a characteristic graph illustrating the relationship between the frequency and the ERP.

FIG. 12 is a perspective view illustrating a structure of a vibration damping member provided in a vehicle according to a second embodiment of the present disclosure.

FIG. 13A is a perspective view illustrating a model that is used in an analysis, and FIG. 13B is a characteristic graph illustrating a relationship between the frequency and PI.

FIG. 14A is a perspective view illustrating a disposed position of the vibration damping member, and FIG. 14B is a characteristic graph illustrating the relationship between the frequency and the ERP.

FIG. 15A is a front view illustrating a vibration damping member that is provided in a vehicle according to a first modified embodiment, FIG. 15B is a side view thereof, FIG. 15C is a front view illustrating a vibration damping member provided in a vehicle according to a second modified embodiment, and FIG. 15D is a front view illustrating a vibration damping member provided in a vehicle according to a third modified embodiment.

FIG. 16A is a front view illustrating a vibration damping member that is provided in a vehicle according to a fourth modified embodiment, FIG. 16B is a bottom view thereof, FIG. 16C is a front view illustrating a vibration damping member provided in a vehicle according to a fifth modified embodiment, and FIG. 16D is a bottom view thereof.

FIG. 17A is a perspective view illustrating a vibration damping member that is provided in a vehicle according to a sixth modified embodiment, FIG. 17B is a perspective view illustrating a vibration damping member that is provided in a vehicle according to a seventh modified embodiment, FIG. 17C is a perspective view illustrating a vibration damping member that is provided in a vehicle according to an eighth modified embodiment, FIG. 17D is a perspective view illustrating a vibration damping member that is provided in a vehicle according to a ninth modified embodiment, and FIG. 17E is a perspective view illustrating a vibration damping member that is provided in a vehicle according to a tenth modified embodiment.

FIG. 18A is a cross-sectional view illustrating a vibration damping member that is provided in a vehicle according to an eleventh modified embodiment, and FIG. 18B is a cross-sectional view illustrating a vibration damping member provided in a vehicle according to a twelfth modified embodiment.

FIG. 19A is a cross-sectional view illustrating a vibration damping member and a top ceiling that are provided in a vehicle according to a thirteenth modified embodiment, FIG. 19B is a cross-sectional view illustrating a vibration damping member and a top ceiling that are provided in a vehicle according to a fourteenth modified embodiment, FIG. 19C is a cross-sectional view illustrating a vibration damping member and a top ceiling that are provided in a vehicle according to a fifteenth modified embodiment, and FIG. 19D is a cross-sectional view illustrating a vibration damping member and a top ceiling that are provided in a vehicle according to a sixteenth modified embodiment.

### DETAILED DESCRIPTION

A description will hereinafter be made on embodiments of the present disclosure with reference to the drawings. The embodiments, which will be described below, each exemplify the present disclosure, and the present disclosure is not limited to the following embodiments in any respect except for an essential configuration thereof.

### First Embodiment

1. Upper Structure of Vehicle 1

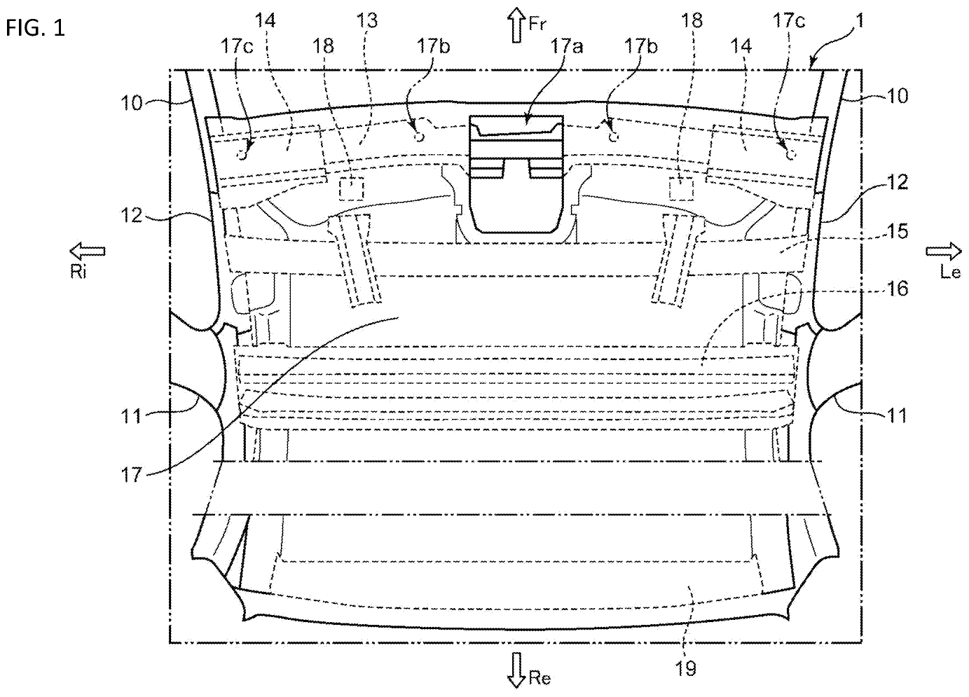

A description will be made on an upper structure of a vehicle 1 according to a first embodiment with reference to FIG. 1. In FIG. 1, a part of the upper structure of the vehicle 1 is extracted for illustration.

As illustrated in FIG. 1, the vehicle 1 includes a roof panel (not illustrated), a right and left pair of front pillars 10, a right and left pair of center pillars 11, a right and left pair of roof side rails 12, a front header (a first body frame member) 13, a right and left pair of gussets 14, a roof reinforcement member (a second body frame member) 15, a roof reinforcement member 16, a rear header 19, a top ceiling 17, and a vibration damping member 18. The roof panel is attached to the front header 13, the roof reinforcement members 15, 16, and the rear header 19.

The front header 13 is joined to a front portion of the roof panel and is configured to extend in a vehicle width direction. The gussets 14 are respectively joined to right and left portions of the front header 13 and to the roof side rails 12. The roof reinforcement members 15, 16 are disposed behind and away from the front header 13, and are also disposed away from each other in a front-rear direction. The rear header 19 is joined to a rear portion of the roof panel and is configured to extend in the vehicle width direction.

The top ceiling 17 is disposed in a manner to cover a cabin side of the roof panel, and is fixed at plural fixed portions to the front header 13, the gussets 14, the roof reinforcement members 15, 16, and the rear header 19. The plural fixed portions include a sun visor fixed portion (a first fixed portion) 17b and a gusset fixed portion (a second fixed portion) 17c. The sun visor fixed portion 17b is a portion in which a sun visor is fixed to the front header 13 with the top ceiling 17 being held therebetween. The gusset fixed portion 17c is a portion in which the top ceiling 17 is fixed to the front header 13 via the gusset 14. The sun visor fixed portions 17b and the gusset fixed portions 17c are disposed in a bilaterally symmetrical manner with an opening 17a, which is provided at a center in a front portion of the top ceiling 17, being held therebetween.

The vibration damping member 18 is joined to an upper surface (a surface on a back side of the sheet of FIG. 1) of the top ceiling 17, and is formed to extend toward the roof panel that is located above.

2. Arrangement of Vibration Damping Member 18

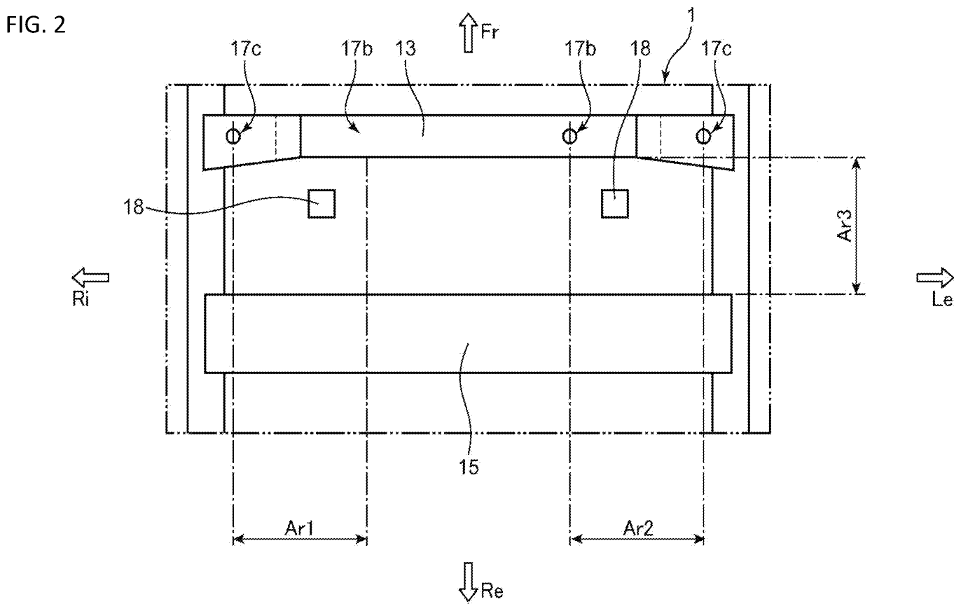

A description will be made on arrangement of the vibration damping member 18 when seen in a plan view with reference to FIG. 2. FIG. 2 schematically illustrates a part of the upper structure of the vehicle 1 illustrated in FIG. 1.

As illustrated in FIG. 2, an imaginary line is drawn rearward from each of the sun visor fixed portion 17b and the gusset fixed portion 17c. In right and left portions in the vehicle width direction, areas Ar1, Ar2 are each located between the imaginary line that passes the sun visor fixed portion 17b and the imaginary line that passes the gusset fixed portion 17c.

Meanwhile, in the front-rear direction, an area Ar3 is located between the front header 13 and the roof reinforcement member 15.

In this case, the vibration damping member 18 is disposed in each of an overlapping area between the area Ar1 and the area Ar3 and an overlapping area between the area Ar2 and the area Ar3.

3. Configuration of Vibration Damping Member 18

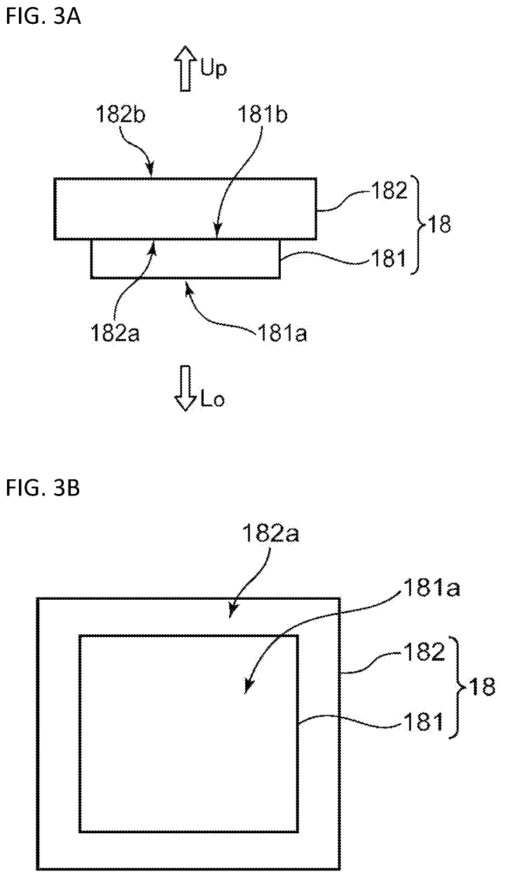

A description will be made on a configuration of the vibration damping member 18 with reference to FIG. 3.

As illustrated in FIGS. 3A-B, the vibration damping member 18 is configured to include: a first portion 181 that has a lower surface 181a joined to the top ceiling 17; and a second portion 182 that has a lower surface 182a connected to an upper surface 181b of the first portion 181. The first portion 181 and the second portion 182 may be formed integrally or may be bonded to each other.

Each of the first portion 181 and the second portion 182 has a rectangular column shape. In addition, as illustrated in FIG. 3B, an area of the second portion 182 in a plan view is larger than that of the first portion 181. Furthermore, the lower surface 182a of the second portion 182 is configured to cover the entire upper surface 181b of the first portion 181. An upper surface 182b of the second portion 182 is disposed in a manner not to contact the roof panel and the like.

Here, in this embodiment, each of the first portion 181 and the second portion 182 is formed from acrylic foam and has a Young's modulus of 0.15 MPa, a loss factor of 0.7, and specific weight of 0.15. In addition, in this embodiment, the vibration damping member 18, which includes the first portion 181 and the second portion 182, has a mass of 24 g.

4. Vibration Modes of Vibration Damping Member 18

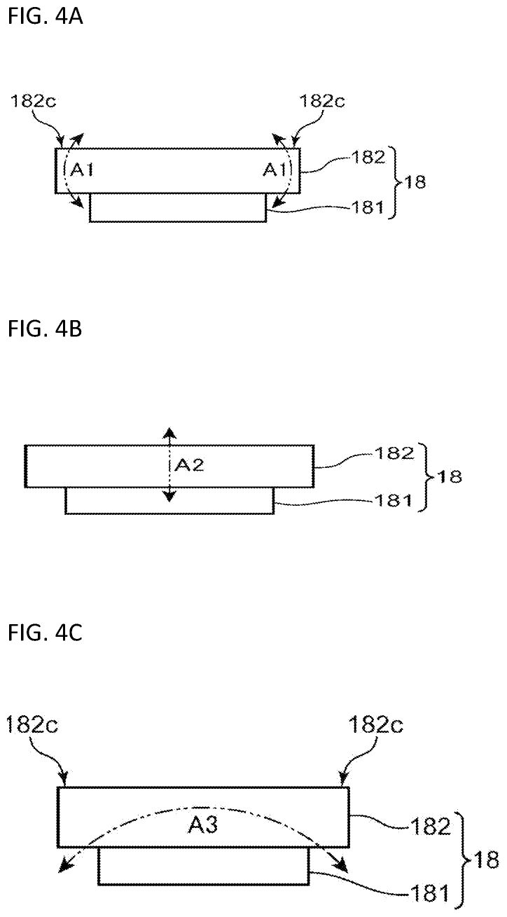

A description will be made on vibration modes of the vibration damping member 18 with reference to FIG. 4.

A first vibration mode illustrated in FIG. 4A is a mode in which end portions 182c of the second portion 182 in the vibration damping member 18 vibrate as indicated by arrows A1. In this mode, the end portion 182c of the second portion 182 can vibrate without being restrained by the first portion 181 since the area of the second portion 182 in the plan view is set to be larger than that of the first portion 181.

A second vibration mode illustrated in FIG. 4B is a mode in which the entire first portion 181 and the entire second portion 182 in the vibration damping member 18 vibrate in a height direction (an up-down direction of the vehicle 1) as indicated by an arrow A2.

A third vibration mode illustrated in FIG. 4C is a mode in which, as indicated by an arrow A3, the entire first portion 181 and the entire second portion 182 vibrate in a manner to collapse with a joined portion (the lower surface 181a of the first portion 181) to the top ceiling 17 being a center.

As it has been described so far, the vibration damping member 18, which is provided in the vehicle 1 according to this embodiment, has an advantage of having more vibration modes than a vibration damping member that is simply configured as a rectangular parallelepiped.

5. Inertance PI

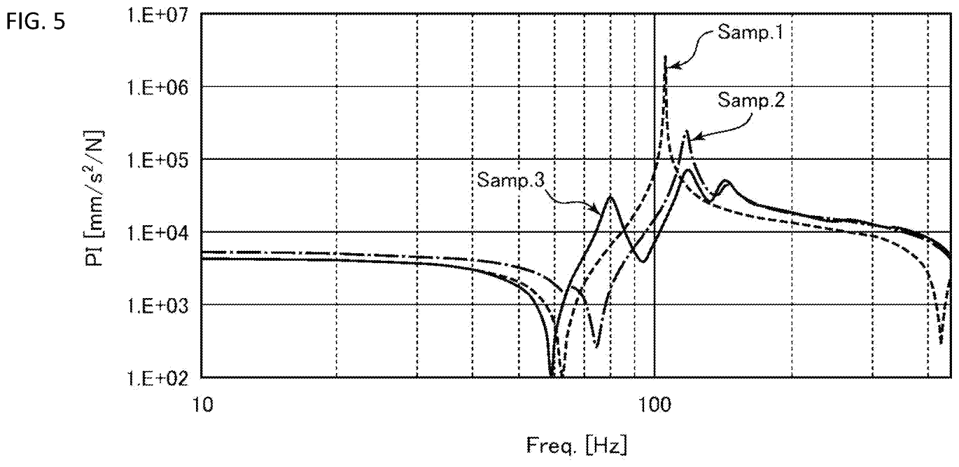

A description will be made on inertance PI (a magnitude of an acceleration amplitude per unit excitation force) of the vibration damping member 18, which is provided in the vehicle 1 according to this embodiment, with reference to FIG. 5. Each of samples 1 to 3 in FIG. 5 has the following configuration.

Sample 1

A sample as a comparative example is a mere weight with mass of 24 g.

Sample 2

A sample as a first example has the same configuration as the vibration damping member 18 and has mass of 7 g.

Sample 3

A sample as a second example has the same configuration as the vibration damping member 18 and has mass of 24 g.

As illustrated in FIG. 5, the sample 1 has a high peak slightly above 100 Hz. The peak of the sample 1 appears at a single point.

Meanwhile, at a slightly higher frequency (about 102 to 103 Hz) than that at the peak of the sample 1, each of the samples 2, 3 has a lower peak than the sample 1. Each of the samples 2, 3 also has a peak at the higher frequency (near 104 to 105 Hz) than the above frequency. The sample 3 further has a peak at about 80 Hz.

As it has been described so far, each of the samples 2, 3 has plural resonance frequencies, and an amplitude thereof at about 100 Hz is reduced to be equal to or smaller than 1/10 of that of the sample 1 as the mere weight.

6. Loss Factor of Vibration Damping Member 18

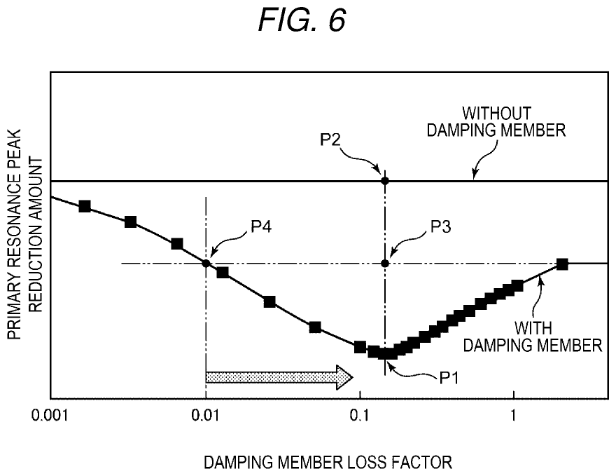

In order to reduce vibration of the top ceiling 17, a desirable loss factor of the vibration damping member 18 was studied. The study result is illustrated in FIG. 6.

In the above examination, a model that included the vibration damping member 18 like the vehicle 1 according to this embodiment was prepared. A model that did not include the vibration damping member was also prepared for comparison.

As illustrated in FIG. 6, in the model including the vibration damping member 18, a primary resonance peak reduction amount is gradually reduced as the loss factor moves from “0.001” to “0.1”. Then, from a point at which the loss factor is slightly larger than “0.1”, the primary resonance peak reduction amount is reversely and gradually increased.

In the model including the vibration damping member 18, P1 is a point at which the primary resonance peak reduction amount is the smallest. A perpendicular line that passes the point P1 is drawn on the graph, and an intersection point thereof with a characteristic line of the model not including the vibration damping member is denoted by P2. Then, a line that is parallel to a horizontal axis passing a midpoint P3 between the point P1 and the point P2 is drawn on a flag. At this time, an intersection point of such a line with a characteristic line of the model including the vibration damping member 18 is denoted by P4.

The loss factor at the point P4 is “0.01”. Accordingly, the vibration damping member 18 with the loss factor of “0.01” or higher can ensure an effect that is at least 50% of a maximum effect with respect to the model not including the vibration damping member.

7. Vibration Test on Test Bed

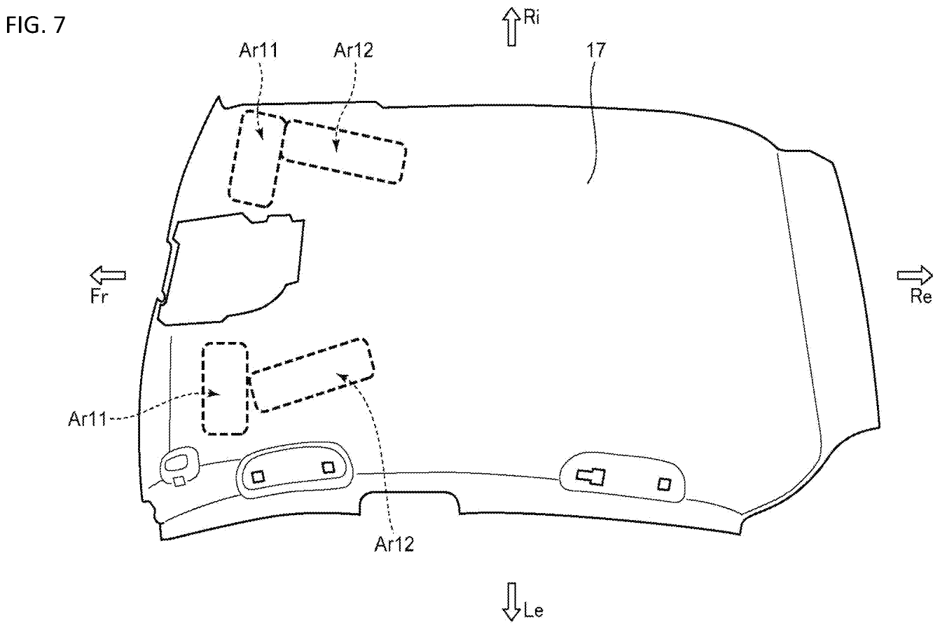

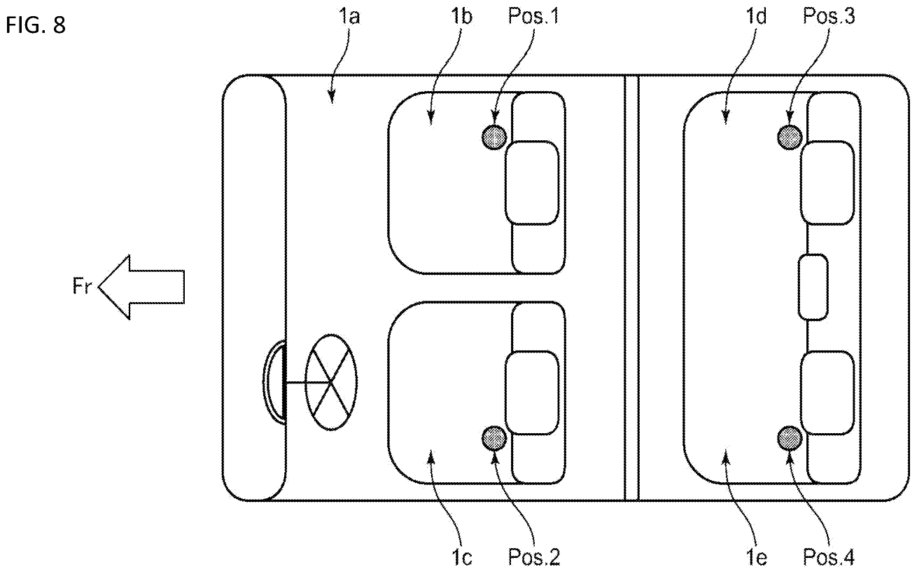

A description will be made on a vibration test on a test bed that was performed by using an actual vehicle with reference to FIG. 7 and FIG. 8.

In the vibration test on the test bed, the following samples were prepared.

Sample 11

A sample 11 is a sample as a comparative example in which the vibration damping member 18 is not attached to the top ceiling 17.

Sample 12

A sample 12 is a sample as an example in which the vibration damping member 18 is attached to an area Ar11 of the top ceiling 17. The area Ar11 is an area that is adjacent to and behind the front header 13 and is located between the sun visor fixed portion 17b and the gusset fixed portion 17c in the vehicle width direction.

Sample 13

A sample 13 is a sample as an example in which the vibration damping member 18 is attached to an area Ar12 of the top ceiling 17. The area Ar12 is an area between the front header 13 and the roof reinforcement member 15 and is also an area between the sun visor fixed portion 17b and the gusset fixed portion 17c in the vehicle width direction.

As illustrated in FIG. 8, in the vibration test on the test bed, body sensitivity (response sensitivity to the vibration) was measured at four positions in a cabin 1a.

More specifically, the body sensitivity was measured at an ear position Pos.1 of an occupant in a front passenger seat 1b, an ear position Pos.2 of a driver in a driver's seat 1c, an ear position Pos.3 of an occupant in a rear seat 1d behind the front passenger seat 1b, and an ear position Pos.4 of an occupant in a rear seat 1e behind the driver's seat 1c.

The measurement results are shown in the following table.

TABLE 1

| | Average | | | |
|---|---|---|---|---|
| | (average of Fr excitation, Rr excitation) | | | |
| | Body sensitivity | | | |
| | Pos.1 | Pos.2 | Pos.3 | Pos.4 |
| Sample 11 | — | — | — | — |
| Sample 12 | −0.6 | −0.4 | −0.3 | −0.5 |
| Sample 13 | −0.5 | −0.6 | −0.2 | −0.7 |

In regard to the body sensitivity in Table 1, as a numerical value thereof becomes smaller, the vibration becomes less significant. The measurement results of the samples 12, 13 are shown with the sample 11 being a reference.

As shown in Table 1, at any of the measurement positions Pos.1 to Pos.4, the samples 12, 13 obtained the smaller values than the sample 11 as the comparative example. It is understood from these results that the noise in the cabin 1a can be reduced with the samples 12, 13, in each of which the vibration damping member 18 is attached to the top ceiling 17.

8. Attachment Position of Vibration Damping Member 18 and ERP

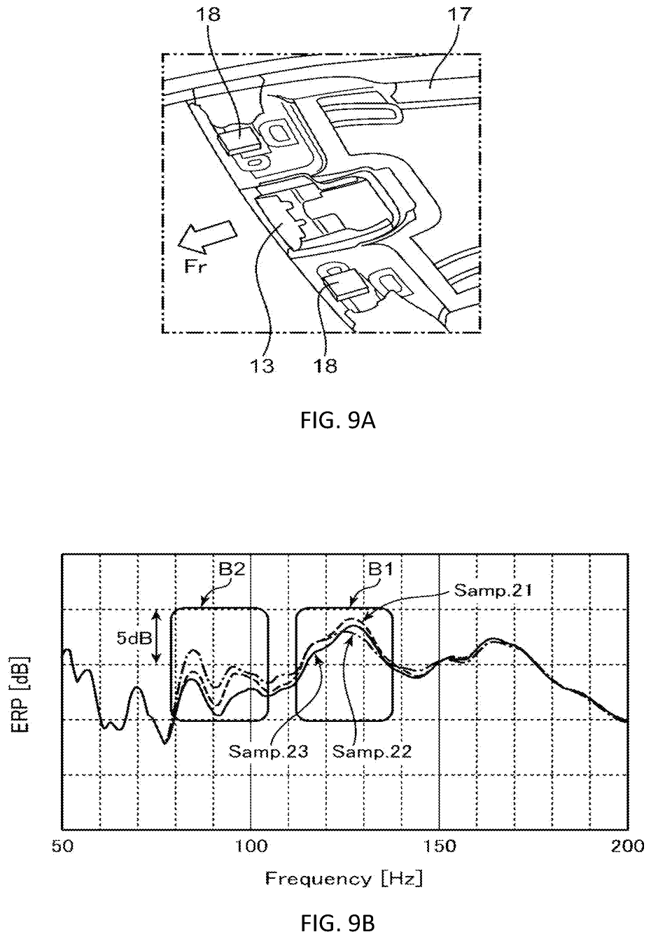

A description will be made on a relationship between an attachment position of the vibration damping member 18 in the top ceiling 17 and equivalent radiated power (ERP) with reference to FIG. 9 to FIG. 11. Each of samples 21 to 23 in FIG. 9 to FIG. 11 has the following configuration.

Sample 21

A sample 21 is a sample as a comparative example in which the vibration damping member 18 is not attached to the top ceiling 17.

Sample 22

A sample 22 is also a sample as a comparative example in which weight of the same mass as the vibration damping member 18 is attached to the top ceiling 17.

Sample 23

A sample 23 is a sample as an example in which the vibration damping member 18 is attached to the top ceiling 17.

As illustrated in FIG. 9A, in the sample 23, the vibration damping member 18 is attached to a front end portion of the top ceiling 17, in other words, onto a straight line that connects the sun visor fixed portion 17b and the gusset fixed portion 17c. In the sample 22, the weight is attached to the same position as the position to which the vibration damping member 18 of the sample 23 is attached.

As illustrated in FIG. 9B, in a frequency range from 110 to 140 Hz (a range indicated by an arrow B1), ERP of each of the samples 22, 23 is less than that of the sample 21. As a result of the investigation by the present inventors and the like, it was found that the vibration at the frequency about 125 Hz had a significant impact on the noise in the cabin 1a.

Accordingly, in the frequency range indicated by the arrow B1, the ERP of each of the samples 22, 23 can be reduced from that of the sample 21 in which neither the vibration damping member nor the weight is attached to the top ceiling 17.

Here, in a frequency range from 80 to 105 Hz indicated by an arrow B2, the ERP of the sample 22 was greater than the ERP of the sample 21. For this reason, in regard to the sample 22 in which the mere weight is attached to the top ceiling 17, the ERP in the frequency range from 80 to 105 Hz is increased while the ERP in the frequency range from 110 to 140 Hz is reduced. Thus, it is considered that the overall vibration damping effect of the sample 22 is low.

Meanwhile, in regard to the sample 23 in which the vibration damping member 18 is attached to top ceiling 17, the ERP is less than that of the sample 21 also in the frequency range from 80 to 105 Hz. Thus, the high vibration damping effect can be obtained with the sample 23.

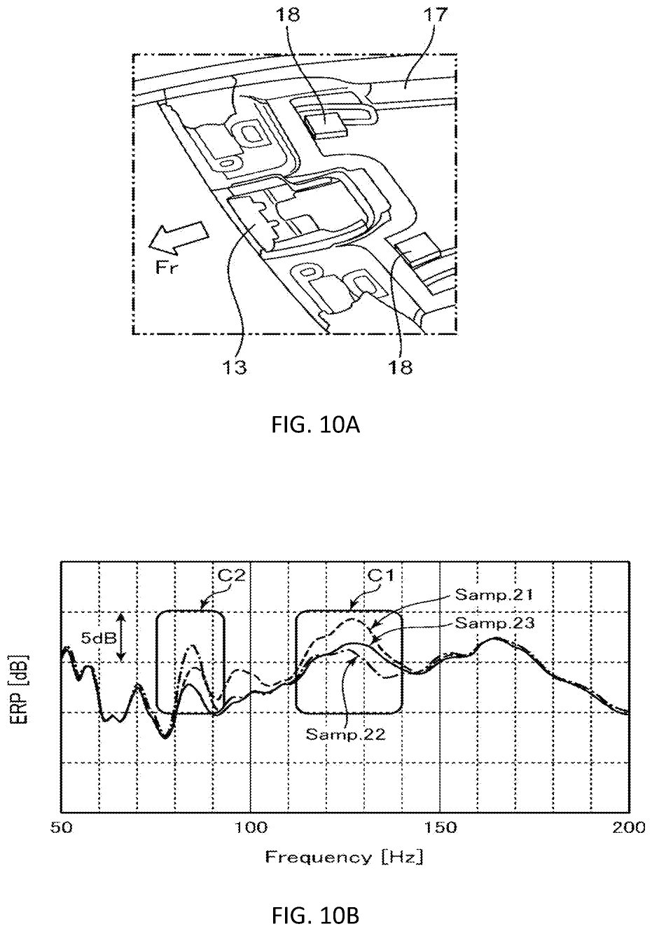

As illustrated in FIG. 10A, in the sample 23, the vibration damping member 18 is attached to a position that is behind the fixed portion of the top ceiling 17 to the front header 13 and that is adjacent to and in front of the fixed portion of the roof reinforcement member 15. In the sample 22, the weight is attached to the same position as the position to which the vibration damping member 18 of the sample 23 is attached.

As illustrated in FIG. 10B, in a frequency range from 110 to 140 Hz (a range indicated by an arrow C1), a value of the ERP of each of the samples 22, 23 is less than that of the sample 21 by 2 to 3 dB. Accordingly, in the frequency range indicated by the arrow C1, the ERP of each of the samples 22, 23 can be reduced from that of the sample 21 in which neither the vibration damping member nor the weight is attached to the top ceiling 17.

In a frequency range from 75 to 95 Hz indicated by an arrow C2, the ERP of the sample 22 was greater than the ERP of the sample 21. For this reason, in regard to the sample 22 in which the mere weight is attached to the top ceiling 17, the ERP in the frequency range from 75 to 95 Hz is increased while the ERP in the frequency range from 110 to 140 Hz is reduced. Thus, it is considered that the overall vibration damping effect of the sample 22 is low.

Meanwhile, in regard to the sample 23 in which the vibration damping member 18 is attached to top ceiling 17, the ERP is less than that of the sample 21 also in the frequency range from 75 to 95 Hz. Thus, the high vibration damping effect can be obtained with the sample 23.

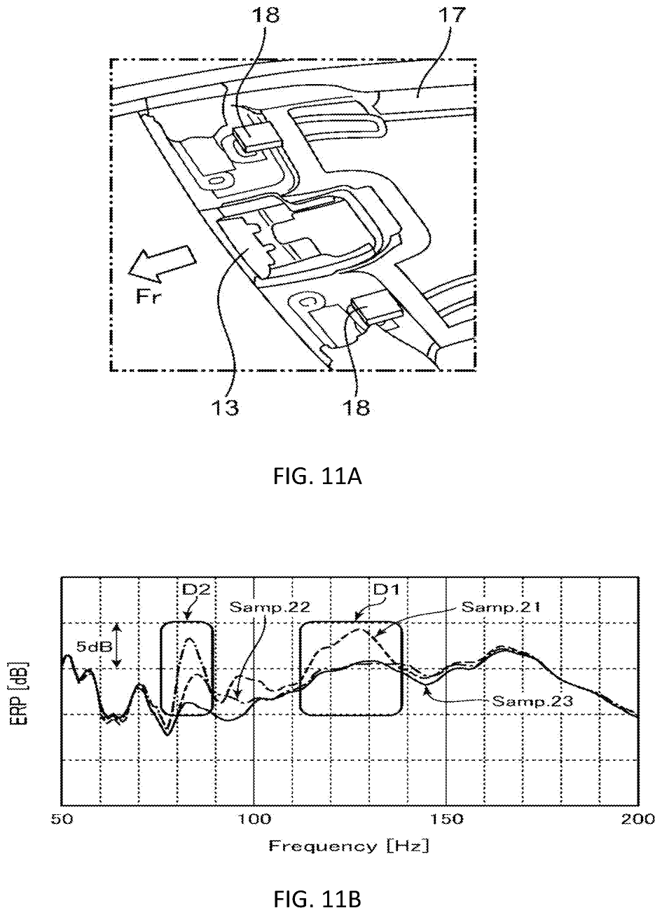

As illustrated in FIG. 11A, in the sample 23, the vibration damping member 18 was attached to an intermediate position between the attachment position illustrated in FIG. 9A and the attachment position illustrated in FIG. 10A in the top ceiling 17. In the sample 22, the weight is attached to the same position as the position to which the vibration damping member 18 of the sample 23 is attached.

As illustrated in FIG. 11B, in the frequency range from 110 to 140 Hz (a range indicated by an arrow D1), the value of the ERP of each of the samples 22, 23 is less than that of the sample 21 by about 4 dB. Accordingly, in the frequency range indicated by the arrow D1, the ERP of each of the samples 22, 23 can be reduced from that of the sample 21 in which neither the vibration damping member nor the weight is attached to the top ceiling 17.

In a frequency range from 80 to 90 Hz indicated by an arrow D2, the ERP of the sample 22 was greater than the ERP of the sample 21 by about 4 dB. For this reason, in regard to the sample 22 in which the mere weight is attached to the top ceiling 17, the ERP in the frequency range from 80 to 90 Hz is increased while the ERP in the frequency range from 110 to 140 Hz is reduced. Thus, it is considered that the overall vibration damping effect of the sample 22 is low.

Meanwhile, in regard to the sample 23 in which the vibration damping member 18 is attached to top ceiling 17, the ERP is less than that of the sample 21 by about 3 dB also in the frequency range from 80 to 90 Hz. Thus, the high vibration damping effect can be obtained with the sample 23.

9. Effects

In the upper structure of the vehicle 1 according to this embodiment, the vibration damping member 18 is arranged near the portion of the top ceiling 17 at which the front header (the first body frame member) 13 is fixed. Therefore, it is possible to prevent an increase in manufacturing cost and an increase in weight in comparison with the structure disclosed in above JP-A-2015-151105 in which the vibration-damping reinforcement member is disposed in the manner to cover the substantially entire upper surface of the top ceiling.

In addition, in the upper structure of the vehicle 1 according to this embodiment, the vibration damping member 18 is arranged in the vehicle width direction between the sun visor fixed portion (the first fixed portion) 17b and the gusset fixed portion (the second fixed portion) 17c. Accordingly, although the top ceiling 17 attempts to vibrate due to vibration energy that is transmitted from the front header 13 to the top ceiling 17 via the sun visor fixed portion 17b and the gusset fixed portion 17c, the vibration damping member 18 that is arranged in the vehicle width direction between the sun visor fixed portion 17b and the gusset fixed portion 17c (a central portion of an area where the vibration occurs) can dampen or reduce the vibration energy.

Furthermore, in the upper structure of the vehicle 1 according to this embodiment, the vibration damping member 18 has the at least two resonance frequencies, and the vibration damping member 18 is formed such that one of the at least two resonance frequencies is substantially the same as the resonance frequency of the top ceiling 17. Accordingly, at the resonance frequency (particularly, about 125 Hz) that is aimed to reduce the vibration of the top ceiling 17, the amplitude can be dampened, and the amplitude can also be dampened at another resonance frequency. Therefore, in the upper structure of the vehicle 1, it is possible to dampen the vibration of the top ceiling 17 in the plural frequency ranges.

In the upper structure of the vehicle 1 according to this embodiment, the loss factor of the vibration damping member 18 is set to 0.01 or higher. Thus, it is possible to obtain the high effect of dampening the vibration of the top ceiling 17.

In the upper structure of the vehicle 1 according to this embodiment, the vibration damping member 18 has the second portion 182, the area of which is larger than that of the first portion 181 in the plan view, and a lateral periphery of the second portion 182 is a free end. Accordingly, the vibration damping member 18 obtains the configuration of having the at least two resonance frequencies, significant distortion of the vibration damping member 18, which is caused by vibration of the free end of the second portion 182, effectively dampens the vibration, and thus the vibration damping member 18 is suitable for preventing the vibration of the top ceiling 17.

In the upper structure of the vehicle 1 according to this embodiment, as described with reference to FIG. 9A, the vibration damping member 18 may be arranged on the imaginary line that connects the sun visor fixed portion 17b and the gusset fixed portion 17c. In this case, in the central portion, which is located between the sun visor fixed portion 17b and the gusset fixed portion 17c, in the area where the vibration occurs, the vibration damping member 18 can dampen the vibration energy, and thus it is possible to prevent the vibration of the top ceiling 17.

In the upper structure of the vehicle 1 according to this embodiment, the vibration damping member 18 may be arranged at the positions described with reference to FIG. 10A and FIG. 11A. In this case, in the central portion of the area where the vibration occurs in both of the vehicle width direction and the front-rear direction, the vibration damping member 18 can dampen the vibration energy.

In the upper structure of the vehicle 1 according to this embodiment, the vibration damping member 18 is arranged near the front header 13. Accordingly, the vibration damping member 18 can reliably receive the vibration that is transmitted from a front suspension via the front header 13. Therefore, in the upper structure of the vehicle 1, it is possible to prevent the noise in the cabin 1a by effectively preventing the vibration of the top ceiling 17.

In the upper structure of the vehicle 1 according to this embodiment, in the vehicle width direction, the vibration damping member 18 is attached between the sun visor fixed portion 17b and the gusset fixed portion 17c. Thus, the vibration damping member 18, which is arranged between the sun visor fixed portion 17b and the gusset fixed portion 17c in the vehicle width direction, can reliably receive the vibration, which is transmitted from the front suspension via the front header 13. Therefore, in the upper structure of the vehicle 1, it is possible to prevent the noise in the cabin 1a by effectively preventing the vibration of the top ceiling 17.

As it has been described so far, in the upper structure of the vehicle 1 according to this embodiment, it is possible to prevent the noise in the cabin 1a by preventing the vibration of the top ceiling 17 while preventing the increase in the manufacturing cost and the increase in the vehicle weight.

### Second Embodiment

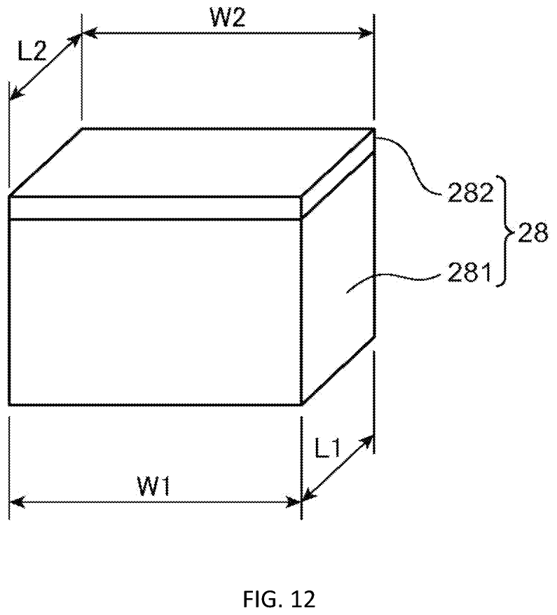

A description will be made on an upper structure of the vehicle 1 according to a second embodiment with reference to FIG. 12. The upper structure of the vehicle 1 according to this embodiment differs from the upper structure of the vehicle 1 in the above first embodiment only in the configuration of a vibration damping member 28, and the other configuration thereof is the same as that in the above first embodiment. For this reason, a description will hereinafter mainly be made on the configuration of the vibration damping member 28 as a part that differs from the above first embodiment.

As illustrated in FIG. 12, the vibration damping member 28 provided in the vehicle 1 according to this embodiment is configured to include: a first portion 281 that is fixed to the top ceiling 17; and a second portion 282 that is joined to an upper portion of the first portion 281. Length and width dimensions L1, W1 of the first portion 281 are substantially the same as length and width dimensions L2, W2 of the second portion 282. In addition, the first portion 281 and the second portion 282 are joined to each other such that the entire vibration damping member 28 has the rectangular parallelepiped shape.

The first portion 281 is formed from an acrylic foam material and has the Young's modulus of 0.15 MPa. The second portion 282 is formed from polyvinyl chloride (PVC) and has the Young's modulus of 1.0 MPa, which is greater than that of the first portion 281.

The vibration damping member 28 provided in the vehicle 1 according to this embodiment is configured to have the loss factor of 0.1 as a whole.

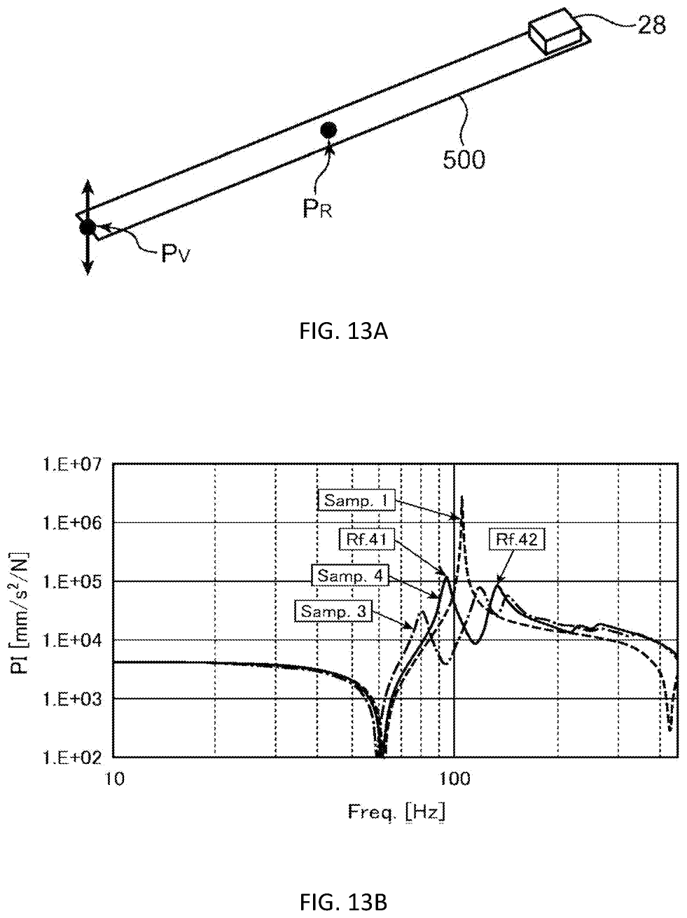

Next, a description will be made on inertance PI of the vibration damping member 28 with reference to FIG. 13.

As illustrated in FIG. 13A, the vibration damping member 28 is attached to one end of an aluminum alloy plate material that is 190 to 210 mm in length, 20 mm in width, and 3 mm in plate thickness. The other end of the aluminum alloy plate material is set as an excitation point P_{V}, and an intermediate point thereof in a longitudinal direction is set as a response point P_{R}.

In FIG. 13B, a sample 4 includes the vibration damping member 28 illustrated in FIG. 12 while the samples 1, 3 are the same samples as those described in the above first embodiment.

As illustrated in FIG. 13B, the sample 1 has the high peak slightly above 100 Hz as described above. The sample 3 has the peaks near 80 Hz, near 102 to 103 Hz, and near 104 to 105 Hz.

Meanwhile, the sample 4 has peaks Rf.41, Rf.42 near 95 Hz and near 103 to 104 Hz, respectively. That is, the vibration damping member 28 provided in the vehicle 1 according to this embodiment also has at least two resonance frequencies.

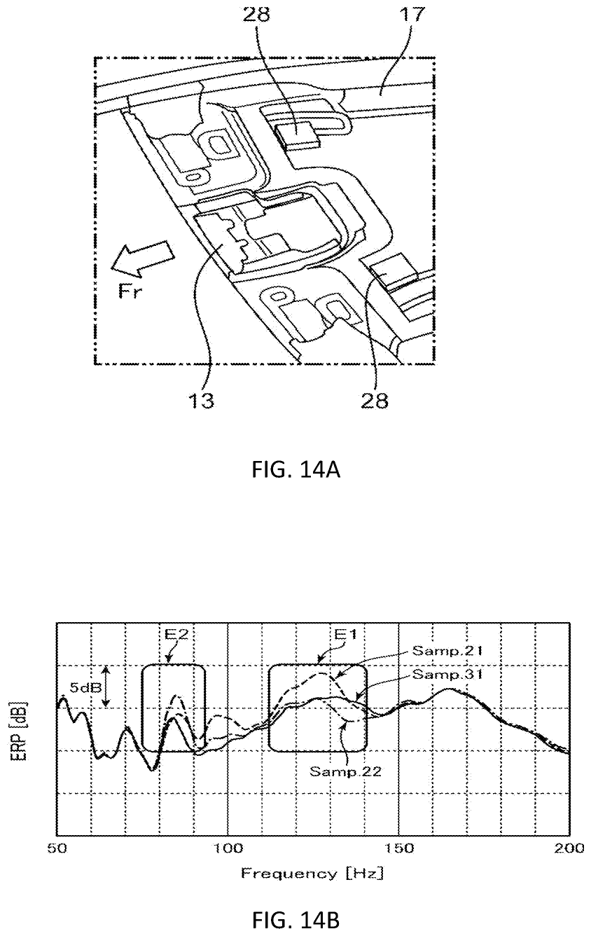

Next, a description will be made on the ERP in the case where the vibration damping member 28 is adopted with reference to FIG. 14.

As illustrated in FIG. 14A, in a sample 31, the vibration damping member 28 is attached to the position that is behind the fixed portion of the top ceiling 17 to the front header 13 and that is adjacent to and in front of the fixed portion of the roof reinforcement member 15. FIG. 14B also illustrates the ERP of the sample 21, in which the vibration damping member 28 is not attached to the top ceiling 17, and the ERP of the sample 22, in which the mere weight (see the above first embodiment) is attached at the same position of the top ceiling 17.

As illustrated in FIG. 14B, in a frequency range from 110 to 140 Hz (a range indicated by an arrow E1), the value of the ERP of each of the samples 22, 31 is less than that of the sample 21 by 2 to 3 dB. Accordingly, in the frequency range indicated by the arrow E1, the ERP of each of the samples 22, 31 can be reduced from that of the sample 21 in which neither the vibration damping member nor the weight is attached to the top ceiling 17.

In a frequency range from 75 to 95 Hz indicated by an arrow E2, the ERP of the sample 22 was greater than the ERP of the sample 21. Meanwhile, in regard to the sample 31 in which the vibration damping member 28 is attached to top ceiling 17, the ERP is less than that of the sample 21 also in the frequency range from 75 to 95 Hz. Thus, the high vibration damping effect can be obtained with the sample 31.

Also in the upper structure of the vehicle 1 according to this embodiment, when the vibration damping member 28 is attached to the top ceiling 17 in the same arrangement as that of the above first embodiment, the high vibration damping effect can be obtained.

The vibration damping member 28 in the rectangular parallelepiped shape as a whole is adopted for the upper structure of the vehicle 1 according to this embodiment, and the lower first portion 281 is formed from the acrylic foam material while the upper second portion 282 is formed from the PVC. For this reason, the second portion 282 is heavier than the first portion 281, and the distortion of the vibration damping member 28 is increased due to expansion/compression vibration of the first portion 281. Thus, the vibration can effectively be dampened. Therefore, even though an overall volume of the vibration damping member 28 is small, the vibration of the top ceiling 17 can effectively be dampened, and the vibration damping member 28 can be disposed in a small space.

### First Modified Embodiment

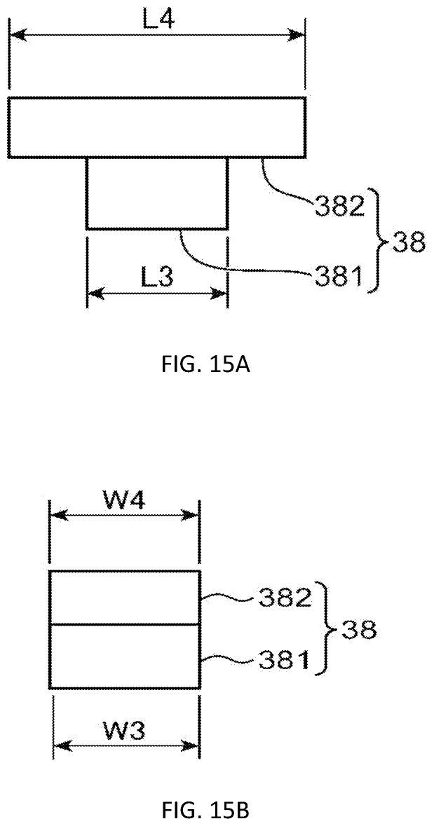

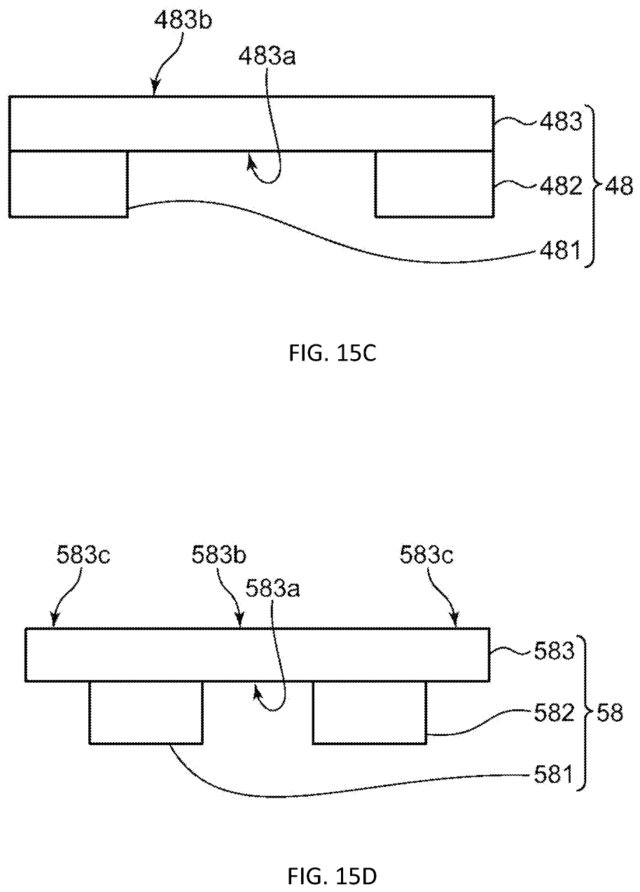

A description will be made on a vibration damping member 38 provided in the vehicle 1 according to a first modified embodiment with reference to FIGS. 15A-B.

As illustrated in FIGS. 15A-B, similar to the above vibration damping member 18, the vibration damping member 38 is configured to include: a first portion 381 that is fixed to the top ceiling 17; and a second portion 382 that is joined to an upper portion of the first portion

While the first portion 381 has a length L3, the second portion 382 has a length L4 that is longer than the length L3. A width W3 of the first portion 381 and a width W4 of the second portion 382 are substantially the same. For this reason, similar to the above first embodiment, an area of the second portion 382 in a plan view is larger than an area of the first portion 381 in the plan view.

Also in the vibration damping member 38, an end portion in a longitudinal direction of the second portion 382 vibrates due to the vibration energy applied from the front header 13 and the like, and the first portion 381 and the second portion 382 vibrate vertically. In this way, the vibration is dampened.

Here, similar to the above first embodiment, each of the first portion 381 and the second portion 382 in the vibration damping member 38 may be formed from the acrylic foam material. Alternatively, similar to the above second embodiment, the first portion 381 may be formed from the acrylic foam material while the second portion 382 may be formed from the PVC. In addition, the vibration damping member 38 also has at least two resonance frequencies and has a loss factor of 0.01 or higher.

### Second Modified Embodiment

A description will be made on a vibration damping member 48 provided in the vehicle 1 according to a second modified embodiment with reference to FIG. 15C.

As illustrated in FIG. 15C, the vibration damping member 48 is configured to include two first portions 481, 482 and a second portion 483. Each of the first portions 481, 482 is a portion that is attached to the top ceiling 17, and is joined to a respective end portion in a longitudinal direction of a lower surface 483a of the second portion 483.

Also in the vibration damping member 48, a central portion in a longitudinal direction of the second portion 483 vibrates due to the vibration energy applied from the front header 13 and the like, and the first portions 481, 482 and the second portion 483 vibrate vertically. In this way, the vibration is dampened.

Here, similar to the above first embodiment, each of the first portions 481, 482 and the second portion 483 in the vibration damping member 48 may be formed from the acrylic foam material. Alternatively, similar to the above second embodiment, the first portions 481, 482 may be formed from the acrylic foam material while the second portion 483 may be formed from the PVC. In addition, the vibration damping member 48 also has at least two resonance frequencies and has a loss factor of 0.01 or higher.

### Third Modified Embodiment

A description will be made on a vibration damping member 58 provided in the vehicle 1 according to a third modified embodiment with reference to FIG. 15D.

As illustrated in FIG. 15D, the vibration damping member 58 is configured to include two first portions 581, 582 and a second portion 583. Each of the first portions 581, 582 is a portion that is attached to the top ceiling 17, and is joined to a portion on a slightly inner side of a respective end portion in a longitudinal direction of a lower surface 583a of the second portion 583.

Also in the vibration damping member 58, a central portion 583b in a longitudinal direction and both of end portions 583c of the second portion 583 vibrate due to the vibration energy applied from the front header 13 and the like, and the first portions 581, 582 and the second portion 583 vibrate vertically. In this way, the vibration is dampened.

Here, similar to the above first embodiment, each of the first portions 581, 582 and the second portion 583 in the vibration damping member 58 may be formed from the acrylic foam material. Alternatively, similar to the above second embodiment, the first portions 581, 582 may be formed from the acrylic foam material while the second portion 583 may be formed from the PVC. In addition, the vibration damping member 58 also has at least two resonance frequencies and has a loss factor of 0.01 or higher.

### Fourth Modified Embodiment

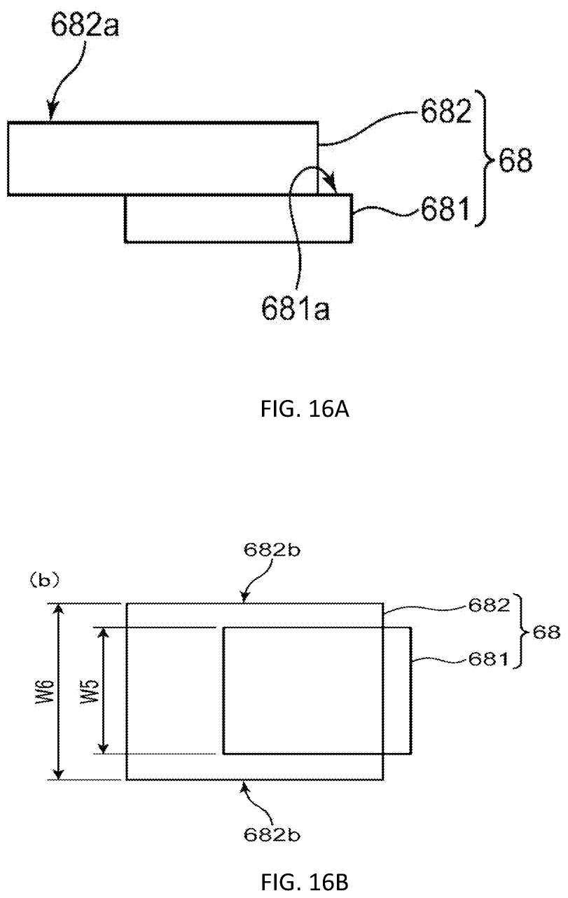

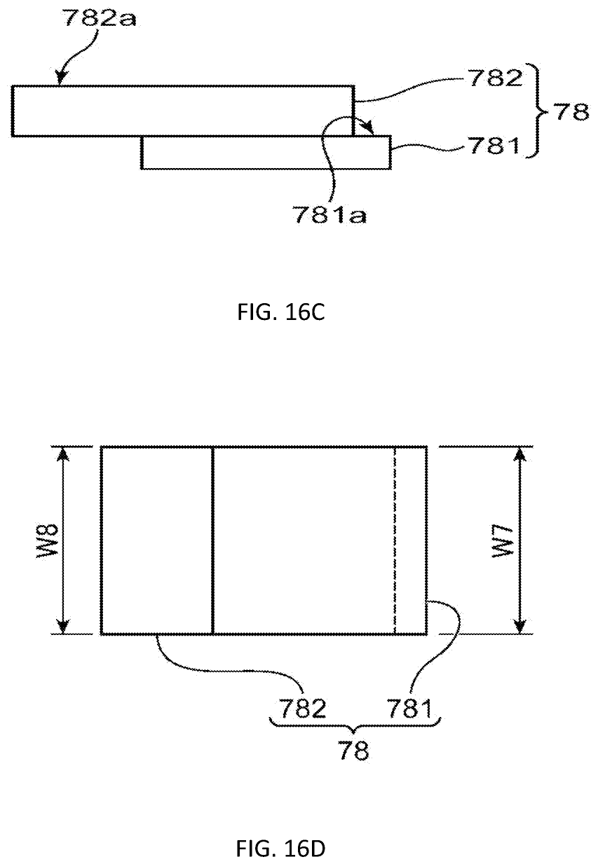

A description will be made on a vibration damping member 68 provided in the vehicle 1 according to a fourth modified embodiment with reference to FIGS. 16A-B.

As illustrated in FIGS. 16A-B, similar to the above vibration damping member 18, the vibration damping member 68 is configured to include: a first portion 681 that is fixed to the top ceiling 17; and a second portion 682 that is joined to an upper portion of the first portion 681.

While the first portion 681 has a width W5, the second portion 682 has a width W6 that is greater than the width W5. In addition, similar to the above first embodiment, an area of the second portion 682 in a plan view is larger than an area of the first portion 681 in the plan view. Meanwhile, in the vibration damping member 68, the second portion 682 is joined such that a part 681a of an upper surface of the first portion 681 is exposed upward. That is, in the vibration damping member 68, the second portion 682 does not completely cover the upper portion of the first portion 681.

Also in the vibration damping member 68, an end portion 682a in a longitudinal direction and an end portion 682b in a width direction of the second portion 682 vibrate due to the vibration energy applied from the front header 13 and the like, and the first portion 681 and the second portion 682 vibrate vertically. In this way, the vibration is dampened.

Here, similar to the above first embodiment, each of the first portion 681 and the second portion 682 in the vibration damping member 68 may be formed from the acrylic foam material. Alternatively, similar to the above second embodiment, the first portion 681 may be formed from the acrylic foam material while the second portion 682 may be formed from the PVC. In addition, the vibration damping member 68 also has at least two resonance frequencies and has a loss factor of 0.01 or higher.

### Fifth Modified Embodiment

A description will be made on a vibration damping member 78 provided in the vehicle 1 according to a fifth modified embodiment with reference to FIGS. 16C-D.

As illustrated in FIGS. 16C-D, similar to the above vibration damping member 18, the vibration damping member 78 is configured to include: a first portion 781 that is fixed to the top ceiling 17; and a second portion 782 that is joined to an upper portion of the first portion 781.

A width W7 of the first portion 781 and a width W8 of the second portion 782 are substantially the same. In addition, similar to the above first embodiment, an area of the second portion 782 in a plan view is larger than an area of the first portion 781 in the plan view. Meanwhile, in the vibration damping member 78 as well, the second portion 782 is joined such that a part 781a of an upper surface of the first portion 781 is exposed upward. That is, also in the vibration damping member 78, the second portion 782 does not completely cover the upper portion of the first portion 781.

Also in the vibration damping member 78, an end portion 782a in a longitudinal direction of the second portion 782 vibrates due to the vibration energy applied from the front header 13 and the like, and the first portion 781 and the second portion 782 vibrate vertically. In this way, the vibration is dampened.

Here, similar to the above first embodiment, each of the first portion 781 and the second portion 782 in the vibration damping member 78 may be formed from the acrylic foam material. Alternatively, similar to the above second embodiment, the first portion 781 may be formed from the acrylic foam material while the second portion 782 may be formed from the PVC. In addition, the vibration damping member 78 also has at least two resonance frequencies and has a loss factor of 0.01 or higher.

### Sixth Modified Embodiment

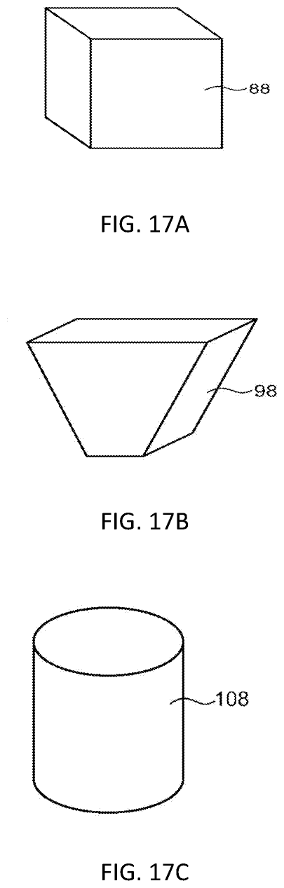

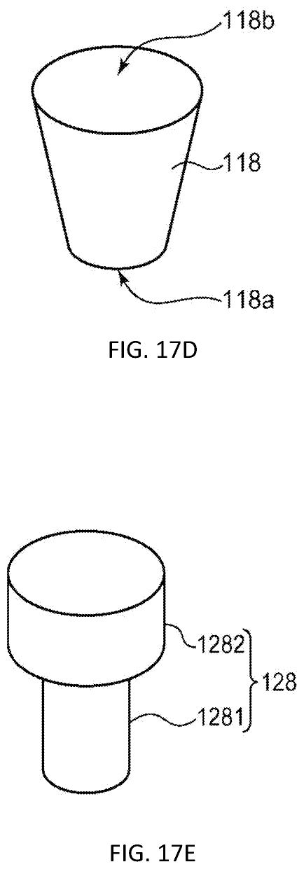

A description will be made on a vibration damping member 88 provided in the vehicle 1 according to a sixth modified embodiment with reference to FIG. 17A.

The vibration damping members 18, 28, which are adopted in the above first embodiment, the above second embodiment, and the like, are configured that the first portions 181, 281 are respectively joined to the second portions 182, 282. However, in this modified embodiment, the vibration damping member 88 having an integral configuration is adopted.

The vibration damping member 88 also has at least two resonance frequencies and has a loss factor of 0.01 or higher. In addition, each of the resonance frequencies can be set appropriately by defining a relationship among a length dimension, a width dimension, and a height dimension of the vibration damping member 88. In this way, also in this modified embodiment, the vibration of the top ceiling 17 can be reduced by the vibration damping member 88.

In addition, in this modified embodiment, the vibration damping member 88 that is formed from a single material is adopted. Thus, compared to a case where a vibration damping member, in which plural members are joined, is adopted, it is possible to prevent the increase in the manufacturing cost.

### Seventh Modified Embodiment

A description will be made on a vibration damping member 98 provided in the vehicle 1 according to a seventh modified embodiment with reference to FIG. 17B.

Also in this modified embodiment, the vibration damping member 98 that is integrally formed by using a single material is adopted. In addition, the vibration damping member 98 also has at least two resonance frequencies and has a loss factor of 0.01 or higher.

The vibration damping member 98 is formed such that a transverse surface thereof gradually expands from a lower portion, which is attached to the top ceiling 17, to an upper portion as a free end, and has a trapezoidal shape in a front view. Also in this modified embodiment, the vibration of the top ceiling 17 can be reduced when the upper portion of the vibration damping member 98 flexes to consume the vibration energy.

In addition, in this modified embodiment, the vibration damping member 98 that is formed from the single material is adopted. Thus, compared to the case where the vibration damping member, in which the plural members are joined, is adopted, it is possible to prevent the increase in the manufacturing cost.

### Eighth Modified Embodiment

A description will be made on a vibration damping member 108 provided in the vehicle 1 according to an eighth modified embodiment with reference to FIG. 17C.

In this modified embodiment, the vibration damping member 108 that is integrally formed and has a column shape is adopted. The vibration damping member 108 also has at least two resonance frequencies and has a loss factor of 0.01 or higher. In addition, each of the resonance frequencies can be set appropriately by defining a mutual relationship between a diameter of a transverse surface and a height dimension of the vibration damping member 108. In this way, also in this modified embodiment, the vibration of the top ceiling 17 can be reduced by the vibration damping member 108.

Also in this modified embodiment, the vibration damping member 108 that is formed from a single material is adopted. Thus, compared to the case where the vibration damping member, in which the plural members are joined, is adopted, it is possible to prevent the increase in the manufacturing cost.

### Ninth Modified Embodiment

A description will be made on a vibration damping member 118 provided in the vehicle 1 according to a ninth modified embodiment with reference to FIG. 17D.

Also in this modified embodiment, the vibration damping member 118 that is integrally formed by using a single material is adopted. In addition, the vibration damping member 118 also has at least two resonance frequencies and has a loss factor of 0.01 or higher.

The vibration damping member 118 is formed such that a diameter of a transverse surface thereof is gradually increased from a lower surface 118a, which is attached to the top ceiling 17, to an upper surface 118b as a free end, and has an inverted conical trapezoidal shape. Also in this modified embodiment, the vibration of the top ceiling 17 can be reduced when an upper portion of the vibration damping member 118 flexes to consume the vibration energy.

Also in this modified embodiment, the vibration damping member 118 that is formed from the single material is adopted. Thus, compared to the case where the vibration damping member, in which the plural members are joined, is adopted, it is possible to prevent the increase in the manufacturing cost.

### Tenth Modified Embodiment

A description will be made on a vibration damping member 128 provided in the vehicle 1 according to a tenth modified embodiment with reference to FIG. 17E.

In this modified embodiment, the vibration damping member 128, in which a first portion 1281 in a column shape and a second portion 1282 in a column shape are integrally formed, is adopted. The vibration damping member 128 also has at least two resonance frequencies and has a loss factor of 0.01 or higher. Also in this modified embodiment, the vibration of the top ceiling 17 can be reduced by the vibration damping member 128.

Also in this modified embodiment, the vibration damping member 128 that is formed from a single material is adopted. Thus, compared to the case where the vibration damping member, in which the plural members are joined, is adopted, it is possible to prevent the increase in the manufacturing cost.

### Eleventh Modified Embodiment

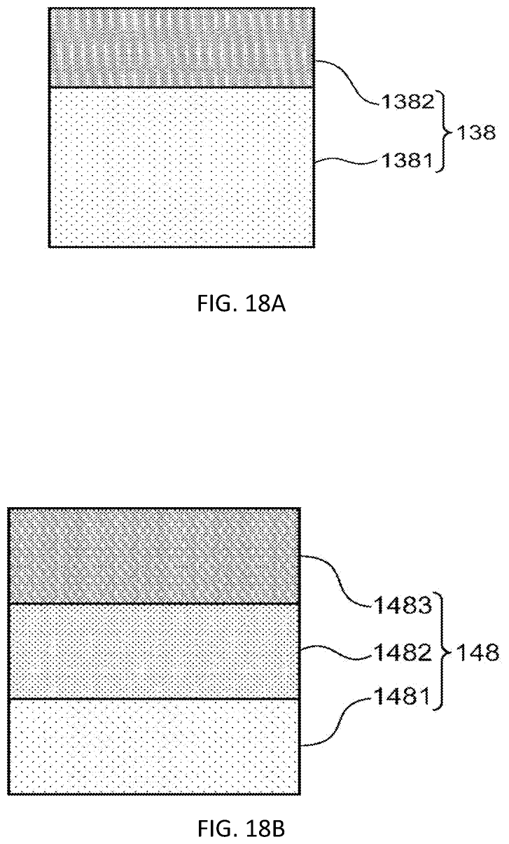

A description will be made on a vibration damping member 138 provided in the vehicle 1 according to an eleventh modified embodiment with reference to FIG. 18A.

As illustrated in FIG. 18A, similar to the above vibration damping member 18, the vibration damping member 138 is also configured to include: a first portion 1381 that is fixed to the top ceiling 17; and a second portion 1382 that is joined to an upper portion of the first portion 1381.

In this modified embodiment, while both of the first portion 1381 and the second portion 1382 are formed from a foam material (for example, the acrylic foam material), density of the second portion 1382 is set to be higher than that of the first portion 1381. In addition, the vibration damping member 138 also has at least two resonance frequencies and has a loss factor of 0.01 or higher.

Also in this modified embodiment, the vibration of the top ceiling 17 can be reduced by the vibration damping member 138.

### Twelfth Modified Embodiment

A description will be made on a vibration damping member 148 provided in the vehicle 1 according to a twelfth modified embodiment with reference to FIG. 18B.

As illustrated in FIG. 18B, the vibration damping member 148 is configured to include: a first portion 1481 that is fixed to the top ceiling 17; an intermediate portion 1482 that is joined to an upper portion of the first portion 1481; and a second portion 1483 that is joined to an upper portion of the intermediate portion 1482.

Also in this modified embodiment, while each of the first portion 1481, the intermediate portion 1482, and the second portion 1482 are formed from the foam material (for example, the acrylic foam material), density of the intermediate portion 1482 is set to be higher than that of the first portion 1481, and density of the second portion 1483 is set to be higher than that of the intermediate portion 1482. In addition, the vibration damping member 148 also has at least two resonance frequencies and has a loss factor of 0.01 or higher.

Also in this modified embodiment, the vibration of the top ceiling 17 can be reduced by the vibration damping member 148.

In the above eleventh modified embodiment, the vibration damping member 138 is configured that the density of the foam material differs between the first portion 1381 and the second portion 1382. In the above twelfth modified embodiment, the vibration damping member 148 is configured that the density of the foam material differs among the first portion 1481, the intermediate portion 1482, and the second portion 1483. However, it is also possible to adopt an integrally-formed vibration damping member configured that density is gradually increased from a lower surface, which is joined to the top ceiling 17, to an upper surface as a free end.

### Thirteenth Modified Embodiment

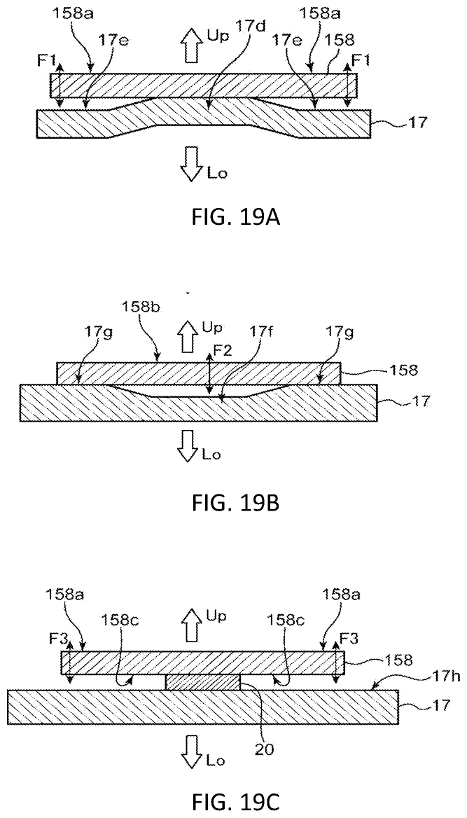

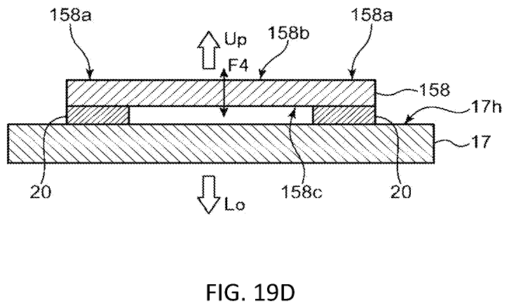

A description will be made on an attachment structure of a vibration damping member 158 to the top ceiling 17 in the vehicle 1 according to a thirteenth modified embodiment with reference to FIG. 19A.

As illustrated in FIG. 19A, in this modified embodiment, the vibration damping member 158 in a strip plate shape is provided. The vibration damping member 158 is attached to a convex portion 17d in the top ceiling 17. A clearance is provided in a portion (a peripheral portion) 17e around the convex portion 17d. In addition, the vibration damping member 158 also has at least two resonance frequencies and has a loss factor of 0.01 or higher.

In the case where the vibration is transmitted to the top ceiling 17, a portion (a separated portion) 158a, which is separated from the top ceiling 17, in the vibration damping member 158 vibrates as indicated by arrows F1, and thereby consumes the vibration energy. Accordingly, the vibration of the top ceiling 17 is dampened by the vibration damping member 158.

### Fourteenth Modified Embodiment

A description will be made on an attachment structure of the vibration damping member 158 to the top ceiling 17 in the vehicle 1 according to a fourteenth modified embodiment with reference to FIG. 19B.

As illustrated in FIG. 19B, also in this modified embodiment, the vibration damping member 158 in the strip plate shape is provided. The vibration damping member 158 is attached to a peripheral portion 17g of a recessed portion 17f in a manner to be provided across the recessed portion 17f of the top ceiling 17.

In the case where the vibration is transmitted to the top ceiling 17, a portion (a separated portion) 158b, which is separated from the top ceiling 17, in the vibration damping member 158, that is, a portion disposed on the recessed portion 17f of the top ceiling 17, vibrates as indicated by an arrow F2, and thereby consumes the vibration energy. Accordingly, the vibration of the top ceiling 17 is dampened by the vibration damping member 158.

### Fifteenth Modified Embodiment

A description will be made on an attachment structure of the vibration damping member 158 to the top ceiling 17 in the vehicle 1 according to a fifteenth modified embodiment with reference to FIG. 19C.

As illustrated in FIG. 19C, also in this modified embodiment, the vibration damping member 158 in the strip plate shape is provided. The vibration damping member 158 is attached to an upper surface 17h of the top ceiling 17 via an adhesive member 20 having a thickness, and a portion of the vibration damping member 158 around a portion, to which the adhesive member 20 adheres, in a lower surface 158c is separated from the upper surface 17h of the top ceiling 17.

In the case where the vibration is transmitted to the top ceiling 17, the separated portion (an end portion in a longitudinal direction) 158a, which is separated from the top ceiling 17, in the vibration damping member 158 vibrates as indicated by arrows F3, and thereby consumes the vibration energy. Accordingly, the vibration of the top ceiling 17 is dampened by the vibration damping member 158.

### Sixteenth Modified Embodiment

A description will be made on an attachment structure of the vibration damping member 158 to the top ceiling 17 in the vehicle 1 according to a sixteenth modified embodiment with reference to FIG. 19D.

As illustrated in FIG. 19D, also in this modified embodiment, the vibration damping member 158 in the strip plate shape is provided. The vibration damping member 158 is attached to the upper surface 17h of the top ceiling 17 via the two adhesive members 20 having the thickness, and a portion of the vibration damping member 158 between the portions, to each of which the adhesive member 20 adheres, in the lower surface 158c is separated from the upper surface 17h of the top ceiling 17.

In the case where the vibration is transmitted to the top ceiling 17, the separated portion (a central portion in the longitudinal direction) 158b, which is separated from the top ceiling 17, in the vibration damping member 158 vibrates as indicated by an arrow F4, and thereby consumes the vibration energy. Accordingly, the vibration of the top ceiling 17 is dampened by the vibration damping member 158.

### Other Modified Embodiments

In the above first embodiment, the above second embodiment, and the above first to sixteenth modified embodiments, each of the vibration damping members 18, 28, 38, 48, 58, 68, 78, 88, 98, 108, 118, 128, 138, 148, 158 has the loss factor of 0.01 or higher. However, the present disclosure is not limited thereto. The loss factor of the vibration damping member may be lower than 0.01 as long as the higher vibration damping effect than the vibration damping effect, which is obtained in the case of not attaching the vibration damping member, is obtained by attaching the vibration damping member to the top ceiling 17.

In the above first embodiment and the above second embodiment, the vibration damping members 18, 28 are attached near the front header 13. However, the present disclosure is not limited thereto. The vibration damping members 18, 28 may be attached near the roof reinforcement members 15, 16 or near the rear header 19. Also in the case of adopting such a configuration, similar to the above first embodiment and the above second embodiment, it is possible to dampen the vibration of the top ceiling 17 and thus to prevent the noise in the cabin 1a to be low. Furthermore, depending on the shape of the top ceiling or the like in the vehicle, the same effect as described above can be obtained by attaching respective one of the vibration damping members 18, 28, 38, 48, 58, 68, 78, 88, 98, 108, 118, 128, 138, 148, 158 to the central portion of the area where the vibration occurs.

In the above first embodiment, the vibration damping member 18 is arranged at the position illustrated in FIG. 9A (the position on the imaginary line connecting the sun visor fixed portion 17b and the gusset fixed portion 17c). However, in the present disclosure, the same effect as described above can be obtained by arranging the vibration damping member near the body frame member. For example, in the case where a linear distance between the first fixed portion (the sun visor fixed portion 17b) and the second fixed portion (the gusset fixed portion 17c) is set as an inter-fixed portion distance, the same effect as described above can be obtained even when the vibration damping member is arranged within a range, a distance from which to the imaginary line connecting the first fixed portion and the second fixed portion is equal to or shorter than the inter-fixed portion distance in the front-rear direction.

What is claimed is:

1. A vehicle upper structure comprising:
a roof panel;
a body frame member that is disposed on an inner side of a cabin from a roof panel and extends in a vehicle width direction;
a top ceiling that is disposed on the inner side of the cabin from the body frame member and covers the roof panel from the inner side of the cabin; and
a vibration damping member that is fixed to an upper surface of the top ceiling on the roof panel side, wherein
the top ceiling has a first fixed portion and a second fixed portion that are fixed to the body frame member at separated positions from each other in the vehicle width direction, and
the vibration damping member is disposed between the first fixed portion and the second fixed portion in the vehicle width direction proximal the body frame member, has at least two resonance frequencies, and is configured such that one resonance frequency of the at least two resonance frequencies is substantially the same as a resonance frequency of the top ceiling.

2. The vehicle upper structure according to claim 1, wherein
the vibration damping member has a loss factor of 0.01 or higher.

3. The vehicle upper structure according to claim 2, wherein
the vibration damping member has a columnar first portion that is fixed to the upper surface and extends toward the roof panel side; and a second portion that is connected to an upper end of the first portion, has a larger area than the first portion in a plan view, and is formed such that at least a part of a lateral periphery thereof is a free end.

4. The vehicle upper structure according to claim 2, wherein
the vibration damping member has a columnar first portion that is fixed to the upper surface and extends toward the roof panel side; and a second portion that is connected to an upper end of the first portion and has a higher Young's modulus than the first portion.

5. The vehicle upper structure according to claim 2, wherein
when a linear distance between the first fixed portion and the second fixed portion is set as an inter-fixed portion distance in a plan view, the vibration damping member is arranged on an imaginary line that connects the first fixed portion and the second fixed portion, or within a range a distance from which to the imaginary line is equal to or shorter than a distance corresponding to the inter-fixed portion distance in a front-rear direction.

6. The vehicle upper structure according to claim 3, wherein
when a linear distance between the first fixed portion and the second fixed portion is set as an inter-fixed portion distance in the plan view, the vibration damping member is arranged on an imaginary line that connects the first fixed portion and the second fixed portion, or within a range a distance from which to the imaginary line is equal to or shorter than a distance corresponding to the inter-fixed portion distance in a front-rear direction.

7. The vehicle upper structure according to claim 4, wherein
when a linear distance between the first fixed portion and the second fixed portion is set as an inter-fixed portion distance in a plan view, the vibration damping member is arranged on an imaginary line that connects the first fixed portion and the second fixed portion, or within a range a distance from which to the imaginary line is equal to or shorter than a distance corresponding to the inter-fixed portion distance in a front-rear direction.

8. The vehicle upper structure according to claim 3 further comprising:
a second body frame member that is arranged between the roof panel and the top ceiling, is arranged behind and away from a first body frame member, and extends in the vehicle width direction when the body frame member is set as the first body frame member, wherein
in the plan view, the vibration damping member is arranged in an area between the first fixed portion and the second fixed portion in the vehicle width direction and in an area between the first body frame member and the second body frame member in the front-rear direction.

9. The vehicle upper structure according to claim 4 further comprising:
a second body frame member that is arranged between the roof panel and the top ceiling, is arranged behind and away from a first body frame member, and extends in the vehicle width direction when the body frame member is set as the first body frame member, wherein
in a plan view, the vibration damping member is arranged in an area between the first fixed portion and the second fixed portion in the vehicle width direction and in an area between the first body frame member and the second body frame member in the front-rear direction.

10. The vehicle upper structure according to claim 8, wherein
the body frame member is a front header.

11. The vehicle upper structure according to claim 10, wherein
the first fixed portion is a sun visor fixed portion at which a sun visor is fixed with the top ceiling to the body frame member, and
the second fixed portion is a gusset fixed portion at which the top ceiling is fixed to the body frame member via a gusset.

12. The vehicle upper structure according to claim 9, wherein
the body frame member is a front header.

13. The vehicle upper structure according to claim 12, wherein
the first fixed portion is a sun visor fixed portion at which a sun visor is fixed with the top ceiling to the body frame member, and
the second fixed portion is a gusset fixed portion at which the top ceiling is fixed to the body frame member via a gusset.

14. The vehicle upper structure according to claim 1, wherein
the vibration damping member has a columnar first portion that is fixed to the upper surface and extends toward the roof panel side; and a second portion that is connected to an upper end of the first portion, has a larger area than the first portion in a plan view, and is formed such that at least a part of a lateral periphery thereof is a free end.

15. The vehicle upper structure according to claim 1, wherein
the vibration damping member has a columnar first portion that is fixed to the upper surface and extends toward the roof panel side; and a second portion that is connected to an upper end of the first portion and has a higher Young's modulus than the first portion.

16. The vehicle upper structure according to claim 1, wherein
when a linear distance between the first fixed portion and the second fixed portion is set as an inter-fixed portion distance in a plan view, the vibration damping member is arranged on an imaginary line that connects the first fixed portion and the second fixed portion, or within a range a distance from which to the imaginary line is equal to or shorter than a distance corresponding to the inter-fixed portion distance in a front-rear direction.

17. The vehicle upper structure according to claim 1 further comprising:
a second body frame member that is arranged between the roof panel and the top ceiling, is arranged behind and away from a first body frame member, and extends in the vehicle width direction when the body frame member is set as the first body frame member, wherein
in a plan view, the vibration damping member is arranged in an area between the first fixed portion and the second fixed portion in the vehicle width direction and in an area between the first body frame member and the second body frame member in the front-rear direction.

18. The vehicle upper structure according to claim 1, wherein
the body frame member is a front header.

19. The vehicle upper structure according to claim 18, wherein
the first fixed portion is a sun visor fixed portion at which a sun visor is fixed with the top ceiling to the body frame member, and
the second fixed portion is a gusset fixed portion at which the top ceiling is fixed to the body frame member via a gusset.

20. The vehicle upper structure according to claim 1, wherein
the body frame member is a rear header.
